(19) United States
(12) Patent Application Publication
(10) Pub. No.: US 2024/0417585 A1
(43) Pub. Date: Dec. 19, 2024

(54) Porous PTFE Article with Hydrophilic Coating

(71) Applicant: Donaldson Company, Inc., Bloomington, MN (US)

(72) Inventors: Matthew P. Goertz, Bloomington, MN (US); S. Kyle Sontag, Plymouth, MN (US); Catherine M. Kasse, Eagan, MN (US)

(21) Appl. No.: 18/742,924

(22) Filed: Jun. 13, 2024

Related U.S. Application Data
(60) Provisional application No. 63/521,067, filed on Jun. 14, 2023.

(51) Int. Cl. C09D 129/04; C08J 3/24; C08J 9/36

(52) U.S. Cl. CPC C09D 129/04; C08J 3/24; C08J 9/365; C08J 2327/18

(57) ABSTRACT

Porous ePTFE articles coated with a hydrophilic coating are provided. The coating may be modified by covalent modifications to the PVOH coating. Covalent modifications may include small molecule grafting, polymer grafting to or from the PVOH backbone, crosslinking of the polymer via thermal or photochemistry, and the like, and combinations thereof. A second polymer coating may be applied onto the PVOH coating. The second polymer may be added, for example, by using a saturation coating technique such as dip coating or spray coating to saturate a PVOH coated ePTFE substrate with a second polymer carried by a fluid. Application of the second polymer may form a second conformal coating over the first PVOH coating.

### CROSS REFERENCE TO RELATED APPLICATIONS

This application claims the benefit of U.S. 63/521,067, filed 14 Jun. 2023, the disclosure of which is incorporated by reference herein in its entirety.

### FIELD

The present disclosure relates to porous articles made of PTFE and including a hydrophilic coating. The present disclosure further relates to porous articles made of ePTFE and including a hydrophilic coating containing PVOH and/or chemically modified PVOH.

### SUMMARY

Porous ePTFE articles coated with a hydrophilic coating are provided.

According to an embodiment, the coating is modified by modifying the PVOH in the coating composition or in the coating (after the coating composition has been applied onto the porous substrate). Such modifications may include covalent modifications to the PVOH coating. Covalent modifications may include small molecule grafting, polymer grafting to or from the PVOH backbone, crosslinking of the polymer via thermal or photochemistry, and the like, and combinations thereof.

Alternatively or in addition, a second polymer may be applied onto the PVOH coating. The second polymer coating may be added, for example, by using a saturation coating technique such as dip coating or spray coating to saturate a PVOH coated ePTFE substrate with a second polymer carried by a fluid. Application of the second polymer may form a second conformal coating over the first PVOH coating.

### BRIEF DESCRIPTION OF DRAWINGS

FIG. 1 is a schematic depiction of a porous article according to embodiments of the present disclosure.

FIG. 2 is a schematic depiction of a filter containing the porous article of FIG. 1.

### DEFINITIONS

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, the terms “polymer” and “polymeric material” include, but are not limited to, organic homopolymers, copolymers, such as for example, block, graft, random and alternating copolymers, terpolymers, etc., and blends and modifications thereof. The term “polymer” further includes different polymer architectures, such as linear, branched, bottle brush, dendrimers, etc. Furthermore, unless otherwise specifically limited, the term “polymer” shall include all possible geometrical configurations of the material. These configurations include, but are not limited to, isotactic, syndiotactic, and atactic symmetries.

The terms “formed from,” “polymerized from,” and “grafter from” are open ended and may include other components that may not be expressly described relative to the subject that is formed from or polymerized from the stated components. For example, a polymer formed from or polymerized from one or more monomers may include capping groups or other groups not expressly mentioned.

The term “grafter to” refers to a technique where an already formed polymer is covalently attach to a surface or another polymer, as the case may be.

The term “grafter from” refers to a polymerization technique where a polymer chain grown from a surface or another polymer. Grafting from may involve polymerization from an initiator-functionalized surface. Polymers that are grafted from may be grown one monomer at a time.

The term “hydrophilic” as used here can be understood to have the meaning of “a tendency to mix with, dissolve in, or be wetted by water”, and can be understood to have the inverse meaning of “hydrophobic.” Hydrophobic materials are defined as materials with a water contact angle greater than 90°, while hydrophilic materials are defined as materials with a water contact angle less than 90°. Hydrophilicity can be measured by measuring the water contact angle of a material using ASTM D7334-08R22 test method, or by using an automated contact angle tester and ASTM D5725-99 test method.

The term “about” is used here in conjunction with numeric values to include normal variations in measurements as expected by persons skilled in the art, and is understood to have the same meaning as “approximately” and to cover a typical margin of error, such as +5% of the stated value.

Terms such as “a,” “an,” and “the” are not intended to refer to only a singular entity, but include the general class of which a specific example may be used for illustration.

The terms “a,” “an,” and “the” are used interchangeably with the term “at least one.” The phrases “at least one of” and “comprises at least one of” followed by a list refers to any one of the items in the list and any combination of two or more items in the list.

As used here, the term “or” is generally employed in its usual sense including “and/or” unless the content clearly dictates otherwise. The term “and/or” means one or all of the listed elements or a combination of any two or more of the listed elements.

The recitations of numerical ranges by endpoints include all numbers subsumed within that range (e.g., 1 to 5 includes 1, 1.5, 2, 2.75, 3, 3.80, 4, 5, etc. or 10 or less includes 10, 9.4, 7.6, 5, 4.3, 2.9, 1.62, 0.3, etc.). Where a range of values is “up to” or “at least” a particular value, that value is included within the range.

As used here, “have,” “having,” “include,” “including,” “comprise,” “comprising,” or the like are used in their open-ended sense, and generally mean “including, but not limited to.” It will be understood that “consisting essentially of,” “consisting of,” and the like are subsumed in “comprising” and the like. As used herein, “consisting essentially of,” as it relates to a composition, product, method, or the like, means that the components of the composition, product, method, or the like are limited to the enumerated components and any other components that do not materially affect the basic and novel characteristic(s) of the composition, product, method, or the like.

The words “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure, including the claims.

Any direction referred to here, such as “top,” “bottom,” “left,” “right,” “upper,” “lower,” and other directions and orientations are described herein for clarity in reference to the figures and are not to be limiting of an actual device or system or use of the device or system. Devices or systems as described herein may be used in a number of directions and orientations.

### DETAILED DESCRIPTION

The present disclosure relates to the application of hydrophilic coatings onto porous ePTFE articles. Expanded polytetrafluoroethylene (“ePTFE”) is manufactured using a stretching process. ePTFE is porous and may be used to provide porous membranes. Such porous membranes may be useful as filter media, separator films, semi-permeable barriers, etc. ePTFE may form one or more layers of filter media and may be used in filters for air and solvent purification.

Polytetrafluoroethylene (PTFE) is a valuable material with a broad array of uses across a variety of industries. Hydrophobicity and low surface energy of PTFE present challenges in certain applications, especially when wetting of a surface area is needed. Attempts to raise the hydrophilicity of PTFE materials have included grafting acrylic acid, 4-vinylpyridine, and N-vinylpyrrolidone on PTFE via ionizing radiation-induced or catalyzed polymerization reactions. With this method, uniform hydrophilicity is not achieved because graft copolymerization acts on the surface layer of the PTFE and does not reach the interior of the material. To overcome this issue and extend graft polymerization into the interior of porous PTFE, impregnation with a surface-active agent and etching are utilized. However, non-uniform hydrophilicity persists with smaller pore sizes.

The hydrophilicity of PTFE materials is especially desirable for providing porous membranes for applications where wetting of the membrane is desired. Such applications include membrane filters, ultrafiltration membranes, dialysis membranes, reverse osmosis membranes, etc. Superior mechanical properties and good permeability are desirable characteristics for hydrophilic polymer membranes used for similar applications.

The creation of a hydrophilic surface on ePTFE membranes presents a challenge. Modifying the surface of ePTFE to make it amenable to wetting for use in filtration applications in the food, beverage, and pharmaceutical industries, is highly desirable.

PTFE is known to be hydrophobic due to the high density of fluorine on the surface which result in a low surface energy. The low surface energy makes PTFE challenging to modify by applying a coating as most materials will not adhere to the surface of PTFE. In some cases, it is desirable to provide PTFE articles with a hydrophilic surface. In some cases, it is desirable to provide PTFE articles with a water wettable surface. Such hydrophilic and wettable surfaces may be achieved by applying a hydrophilic coating containing poly(vinyl alcohol) (“PVOH”) onto the surface of PTFE. Such hydrophilic and wettable surfaces may further be achieved by applying a hydrophilic coating containing PVOH onto porous ePTFE.

The present disclosure relates to improvements to hydrophilic-coated ePTFE articles, including hydrophilic-coated ePTFE membranes, films, and filter media. According to an embodiment, the ePTFE article includes a porous ePTFE substrate coated with a coating composition containing PVOH.

Generally, PVOH may be applied onto the porous substrate (e.g., porous ePTFE film or membrane) by applying PVOH in an aqueous solution, creating a thin film of PVOH on the porous substrate. The solution may optionally be removed, although removal is not necessary for the formation of the PVOH coatings on the PTFE. The PVOH may be subsequently crosslinked. For example, the porous substrate may be coated by immersing, dip coating, spraying, printing, or brushing a coating composition onto the porous substrate. The porous substrate may be prewetted prior to coating. The coated substrate may be rinsed after coating. The coating composition may be dried and/or cured onto the porous substrate. In one exemplary embodiment, the porous substrate is prewetted using water or an aqueous solvent composition or a water miscible solvent such as acetone, ethanol, or isopropanol. The solvent may be displaced with water. The substrate (still wet with water) may be placed in contact with an aqueous bath containing the coating composition.

The concentration of PVOH in the aqueous solution may be 0.1 wt-% or greater, 0.2 wt-% or greater, 0.5 wt-% or greater, 1 wt-% or greater, 2 wt-% or greater, 3 wt-% or greater, 4 wt-% or greater, or 5 wt-% or greater. The concentration of PVOH in the aqueous solution may be 20 wt-% or less, 10 wt-% or less, 5 wt-% or less, 4 wt-% or less, 3 wt-% or less, or 2 wt-% or less. The hydrolyzation rate of the PVOH may be 88% or greater, 90% or greater, 95% or greater, 98% or greater, or 99% or greater. The molecular weight of the PVOH may be 50 kDa or greater, 75 kDa or greater, or 80 kDa or greater. The molecular weight of the PVOH may be 120 kDa or less, 100 kDa or less, or 90 kDa or less. In some embodiments, the PVOH is 99% or more hydrolyzed, has a molecular weight of 80 kDa to 90 kDa, and is included in water at a concentration of 1.5 wt-% to 2.5 wt-%.

For example, the substrate may be placed in an aqueous bath containing 1-2 wt-% of fully (99%) hydrolyzed poly(vinyl alcohol) for at least 2 minutes. The aqueous bath may be at room temperature or above room temperature. Room temperature is understood to mean a temperature of about 20° C. to 26° C. The substrate may then be rinsed. A crosslinking composition containing a crosslinking agent suitable for crosslinking the coating composition (e.g., PVOH) may be applied onto the substrate. In some embodiments, the substrate may be rinsed with water and immersed in an aqueous solution of glutaraldehyde and H₂SO₄ at an elevated temperature. For example, the substrate may be immersed in an aqueous solution of 2 mM to 8 mM (e.g., about 5 mM) glutaraldehyde and 0.1 M to 0.5 M (e.g., about 0.25 M) H₂SO₄ at a temperature of 40° C. to 80° C. (e.g., about 60° C.) for 1 minute to 5 minutes (e.g., about 2 minutes).

The coating composition may penetrate the porous substrate at least part of the way such that internal surfaces, such as surfaces of individual fibers or surfaces of pores become coated. In some embodiments, the coating composition penetrates the porous substrate all the way such that both major surfaces as well as internal surfaces are coated. According to an embodiment, the coatings according to the present disclosure may be characterized as being conformal. The term “conformal” as used here refers to a coating that follows the surface contours of the base layer so that the coating is present on the whole surface irrespective of surface roughness or defects.

According to an embodiment, the coating may be modified by modifying the PVOH in the coating composition or in the coating (after the coating composition has been applied onto the porous substrate). Such modifications may be applied to alter the polymer surface and its mechanical properties. The modifications may include covalent modifications to the PVOH coating. Covalent modifications may include small molecule grafting, polymer grafting to or from the PVOH backbone, crosslinking of the polymer via thermal or photochemistry, and the like, and combinations thereof. This polymer will have a different chemical composition than unmodified PVOH coatings.

Alternatively or in addition, a second polymer may be applied onto the PVOH coating. Such a second coating may be utilized to improve the thermodynamic stability of PVOH (a high surface energy polymer) coated onto ePTFE (a lower surface energy substrate). The second polymer may be added, for example, by using a saturation coating technique such as dip coating or spray coating to saturate a PVOH coated ePTFE substrate with a second polymer carried by a fluid. This may be followed by removal of the carrier fluid through drying. Application of the second polymer may form a second conformal coating over the first PVOH coating.

In some embodiments, the PVOH coating is modified by grafting biomolecules onto the PVOH coating. This may improve the biocompatibility of the resulting coated porous article. Examples of such biomolecules include amino acids, peptides, proteins, saccharides, polysaccharides, oligosaccharides, and the like. In some embodiments, the PVOH coating is modified by grafting starch, chitosan, cellulose, gelatin, heparin, synthetic polypeptides, or a combination of two or more thereof onto the PVOH. The coupling may be done using known coupling chemistries. In some embodiments, PVOH is coupled via glutaraldehyde, dicyclohexylcarbodiimide, carbonyldiimidazole, or other carbodiimide chemistry, disuccinimidyl carbonate, epichlorohydrin, or other suitable coupling agent. The grafting may involve contacting the PVOH with the biomolecule of interest and a coupling agent. The biomolecule to be coupled with the PVOH may be included at a rate of 0.1 wt-% to 100 wt-% based on the weight of the PVOH. In addition, a modified PVOH containing the appropriate functional group can be further reacted with a biomolecule of interest containing maleimide derivatives, iodoacetamide derivatives, alkyne-azide chemistry derivatives, thiol-ene chemistry derivatives, thiol-yne chemistry derivatives, isocyanate derivatives, or the like, including other reactive group derivatives known as click chemistry or covalent bioconjugation techniques, to increase biocompatibility. A method of forming the coated article may include covalently coupling the biological molecule to the poly(vinyl alcohol), where the biological molecule has a first reactive handle, and the poly(vinyl alcohol) has a second reactive handle, and where the first reactive handle and the second reactive handle are cooperative and react in a bioconjugation reaction.

In some embodiments, the PVOH coating is modified by grafting oligomers and/or polymers onto the PVOH coating. The PVOH coating is modified by attaching a second fully formed polymer onto the PVOH. The second polymer may be a hydrophilic polymer having a molecular weight of 500 Da to 100 kDa. The second may be grafted to the PVOH backbone using known grafting chemistries. Exemplary grafting technique include coupling via glutaraldehyde, dicyclohexylcarbodiimide or other carbodiimide chemistry, carbonyldiimidazole, disuccinimidyl carbonate, epichlorohydrin, or other suitable coupling agent. The grafting may involve contacting the PVOH with the second polymer, and the coupling agent. In addition, a modified PVOH containing a functional group can be further reacted with a modified hydrophilic polymer of interest containing one or more reactive handles, such as maleimide derivatives, iodoacetamide derivatives, alkyne-azide chemistry derivatives, thiol-ene chemistry derivatives, thiol-yne chemistry derivatives, isocyanate derivatives, or the like, including other reactive group derivatives known as click chemistry or conjugation techniques. Example polymers to be grafted include polyethylene glycol (PEG), linear polyethylene imine (PEI), polyallyl alcohol (PAIA), polyacrylic acid (PAA), polyacrylic acid sodium salt (PAANa), and poly(2-hydroxyethyl methacrylate) (PHEMA).

In some embodiments, the PVOH coating is modified by grafting polymers and/or oligomers through grafting-from technology such as surface initiated polymerization onto the PVOH coating. Hydrophilic polymers (e.g., PEG, polyglycidyl ether, polylactides, polycarbonates, having repeat units with N=1-100) can be grafted from PVOH through use of ring opening polymerization of ethylene oxides, other cyclic ether, cyclic esters, or cyclic carbonate derivatives, through acid or base catalyzed ring-opening polymerizations. Hydrophilic acrylate derivatives (e.g., polyacrylic acid (PAA), polyacrylic acid sodium salt (PAANa), poly(2-hydroxyethyl methacrylate) (PHEMA), having repeat units with N=1-100) can be grafted from the PVOH polymer through PVOH modification with an atom transfer radical polymerization (ATRP) initiator (e.g., α-haloester derivatives, or other common ATRP initiators). Hydrophilic acrylate derivatives can also be grafted from the PVOH polymer through modification of the PVOH with a reversible addition-fragmentation chain-transfer polymerization (RAFT) initiator (dithiocarbonyl derivative, thiocarbonylthio derivative or other common chain transfer agents (CTAs)).

In some embodiments, a second polymer is applied as a second coating onto the PVOH coating. The deposition of the PVOH coating may be followed by at least a second coating of a water-insoluble polymer through removal of a carrier liquid that contains the second polymer. Examples of suitable polymers include poly(lactic-co-glycolic acid), poly(ethyleneimine), and poly(2-hydroxyethylmethacrylate). Such polymers may be water soluble prior to application and crosslinking and may become water insoluble upon crosslinking. In an exemplary embodiment, the PVOH is coated onto an ePTFE substrate, followed removal of the solution to leave a residual PVOH film on the ePTFE. The coated substrate is then contacted with a solution of poly(lactic-co-glycolic acid) in tetrahydrofuran to form the second coating. In another example, the second polymer is poly(ethyleneimine) in methanol with a crosslinking agent of formaldehyde. The methanol is evaporated and the crosslinking occurs at 90° C. for 10 minutes. In another example, poly(2-hydroxyethylmethacrylate) is deposited from isopropanol and the isopropanol is evaporated.

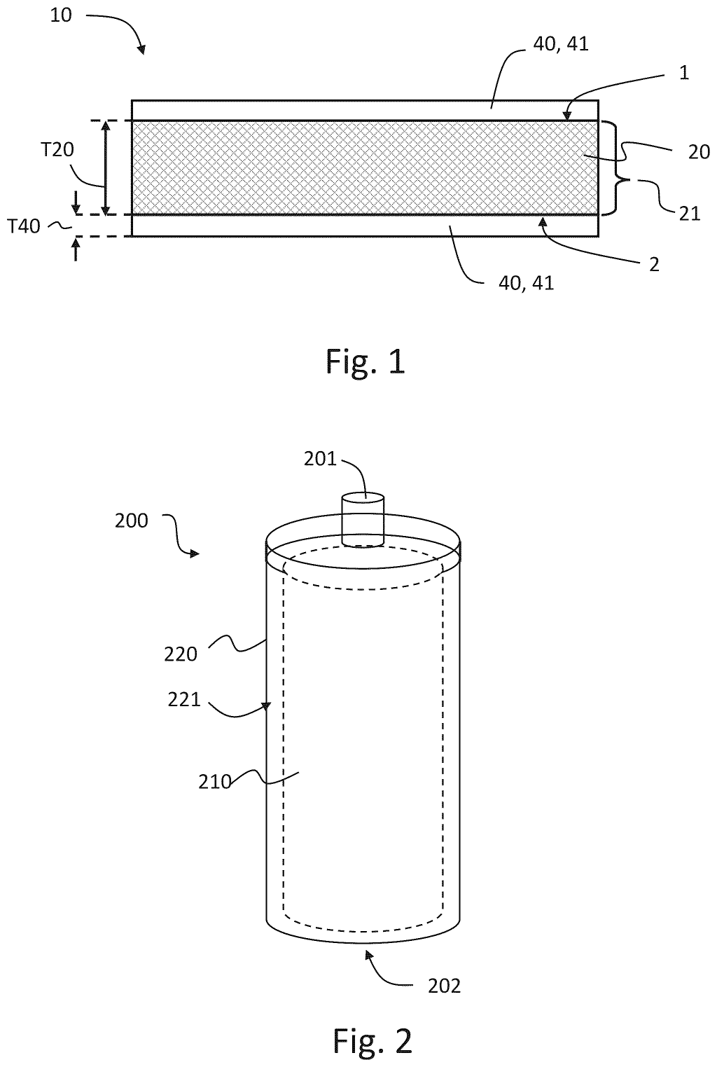

Reference is now made to FIGS. 1 and 2. The present disclosure describes coated porous article 10. The coated porous article 10 may be used as filter media. The present disclosure further describes filters 200 including the coated porous article 10 (e.g., filter media), methods of making the coated porous article 10, and methods of using the coated porous article 10 (e.g., filter media). It should be noted that although the figures show a coated filter media, the methods of the present disclosure may also be used to apply coatings to surfaces of other articles. In particular, the methods of the present disclosure may be useful for applying coatings onto articles including ePTFE that include a porous surface that may benefit from the hydrophilic coating.

The coated porous article 10 of the present disclosure, as schematically shown in FIG. 1, generally includes a porous substrate 20 that is coated with a coating 40 that includes a hydrophobic coating composition 41. The coating may be present on the major surfaces 1, 2 of the porous substrate 20 and also on surfaces of pores. Although the coating 40 is shown as solid layers in FIG. 1, the coating 40 may at least partially coat each fiber and surfaces of pores of the porous substrate 20. That is, the coating 40 may form a conformal coating on the porous substrate 20. The porous substrate may have a thickness T20 and the coating 40 may have a thickness T40.

A filter 200 is shown in FIG. 2. The filter 200 may include a housing 220 with an interior 221, an inlet 201, and outlet 202. A filter media 210 made of or including the coated porous article is disposed within the interior 221 or the housing 220.

The porous substrate may be provided as a thin film or membrane. The porous substrate may have any thickness suitable for its intended purpose. The porous substrate may have a thickness of 0.1 μm or greater, 0.5 μm or greater, 1 μm or greater, 5 μm or greater, 10 μm or greater, or 100 μm or greater. The porous substrate may have a thickness of 5 mm or less, 2 mm or less, 1 mm or less, 500 μm or less, 200 μm or less, 100 μm or less, 50 μm or less, 25 μm or less, 10 μm or less, 5 μm or less, 2 μm or less, or 1 μm or less.

According to an embodiment, the coating forms a very thin layer on the porous substrate. Preferably, the coating is thin enough so as not to clog the pores of the porous substrate. The coating may have a thickness of 250 nm or less, 200 nm or less, 150 nm or less, 100 nm or less, 50 nm or less, 20 nm or less, 10 nm or less, or 5 nm or less. The coating may have a thickness of 0.5 nm or greater.

The coated porous substrate may have an average pore size of 1 mm or less, 100 μm or less, 10 μm or less, 1 μm or less, 0.6 μm or less, 0.5 μm or less, 0.4 μm or less, 0.3 μm or less, 0.2 μm or less, 0.1 μm or less, or 0.01 μm or less. The porous substrate may have an average pore size of 1 nm or greater, 5 nm or greater, 10 nm or greater, 0.1 μm or greater, 1 μm or greater, 10 μm or greater, or 100 μm or greater. The average pore size of the porous substrate may be in a range of 1 nm to 1 mm, 1 nm to 1 μm, 1 nm to 0.5 μm, 0.1 μm to 0.6 μm, 1 μm to 1 mm, or 100 μm to 1 mm. A method for measuring pore size is described in ASTM D6767-21.

The permeability of the porous substrate or coated porous article may be measured by measuring its Frazier permeability as described in ASTM D737-18, using a Frazier Permeability Tester available from Frazier Precision Instrument Co. Inc., Gaithersburg, Maryland. The unit for Frazier permeability is 1 cfm/ft² at 0.5″ water pressure drop, which is equivalent to 0.5 cm³/s/cm² at 125 Pa. In some embodiments, the coated porous article 10 (e.g., filter media) has a permeability of 0.02 cm³/s/cm² or greater, 0.05 cm³/s/cm² or greater, 0.1 cm³/s/cm² or greater, 0.2 cm³/s/cm² or greater, 0.3 cm³/s/cm² or greater, or 0.5 cm³/s/cm² or greater. The permeability of the coated porous article 10 (e.g., filter media) may be 2 cm³/s/cm² or less, 1.5 cm³/s/cm² or less, 1.0 cm³/s/cm² or less, or 0.8 cm³/s/cm² or less.

The coated porous article exhibits improved wettability as compared to uncoated ePTFE membranes. According to embodiments, the coated porous article includes a coating that renders the article wettable with water. The term “wettable,” as used here, refers to a material that allows a fluid to spread evenly across its surface. In the case of a porous wettable material, the fluid will penetrate into the material and spread throughout the material, including into the pores. Wettability of materials may be measured by ASTM D7334-08R22 test method.

### Embodiments

The following is a list of various embodiments of the present disclosure.

Embodiment 1 is a porous article comprising:
a porous substrate comprising ePTFE; and
a coating disposed on the porous substrate, the coating comprising poly(vinyl alcohol) and a biological molecule covalently attached to the poly(vinyl alcohol).

Embodiment 2 is the porous article of embodiment 1, wherein the biological molecule comprises an amino acid, a polypeptide, a saccharide, or a polysaccharide.

Embodiment 3 is the porous article of embodiment 1 or 2, wherein the biological molecule comprises a first reactive handle, and the poly(vinyl alcohol) comprises a second reactive handle, and wherein the first reactive handle and the second reactive handle are cooperative and react in a bioconjugation reaction.

Embodiment 4 is a method of forming a porous article comprising:
a porous substrate comprising ePTFE; and
a coating disposed on the porous substrate, the coating comprising poly(vinyl alcohol) and a biological molecule covalently attached to the poly(vinyl alcohol),
the method comprising:
   applying a coating composition onto the porous substrate, the coating composition comprising poly(vinyl alcohol) and the biological molecule; and
   covalently coupling the biological molecule to the poly(vinyl alcohol).
      Embodiment 5 is the method of embodiment 4, wherein the biological molecule and the poly(vinyl alcohol) react in a bioconjugation reaction.

Embodiment 6 is a porous article comprising:
a porous substrate comprising ePTFE; and
a coating disposed on the porous substrate, the coating comprising poly(vinyl alcohol) and a second polymer grafted on the poly(vinyl alcohol).

Embodiment 7 is the porous article of embodiment 6, wherein the second polymer comprises polyethylene glycol (PEG), linear polyethylene imine (PEI), polyallyl alcohol (PAIA), polyacrylic acid (PAA), polyacrylic acid sodium salt (PAANa), poly(2-hydroxyethyl methacrylate) (PHEMA), or any combination thereof.

Embodiment 8 is a method of forming a porous article comprising:
a porous substrate comprising ePTFE; and
a coating disposed on the porous substrate, the coating comprising poly(vinyl alcohol) and a second polymer grafted to the poly(vinyl alcohol),
the method comprising:
   applying a coating composition onto the porous substrate, the coating composition comprising the poly(vinyl alcohol) and the second polymer; and
   covalently coupling the second polymer to the poly(vinyl alcohol) to form the porous article.

Embodiment 9 is the method of embodiment 8, wherein the covalently coupling the second polymer to the poly(vinyl alcohol) comprises reacting a coupling agent with the poly(vinyl alcohol) and the second polymer.

Embodiment 10 is the method of embodiment 8 or 9, wherein the coupling agent comprises glutaraldehyde, carbodiimide (optionally dicyclohexylcarbodiimide), carbonyldiimidazole, disuccinimidyl carbonate, epichlorohydrin, or a combination of two or more thereof.

Embodiment 11 is the method of any one of embodiments 8 to 10, wherein the second polymer comprises polyethylene glycol (PEG), linear polyethylene imine (PEI), polyallyl alcohol (PAIA), polyacrylic acid (PAA), polyacrylic acid sodium salt (PAANa), poly(2-hydroxyethyl methacrylate) (PHEMA), or a combination of two or more thereof.

Embodiment 12 is the method of embodiment 8, wherein the poly(vinyl alcohol) comprises a modified poly(vinyl alcohol) comprising a functional group, the method further comprising reacting the functional group with a modified hydrophilic polymer comprising a maleimide, iodoacetamide, alkyne, azide, thiol-ene, thiol-yne, isocyanate, or a combination thereof.

Embodiment 13 is a porous article comprising:
a porous substrate comprising ePTFE; and
a first coating disposed on the porous substrate, the coating comprising poly(vinyl alcohol); and
a second coating disposed on the first coating, the second coating comprising a water-insoluble polymer.

Embodiment 14 is the porous article of embodiment 13, wherein the water-insoluble polymer comprises poly(2-hydroxylethylmethacrylate).

Embodiment 15 is the porous article of embodiment 13, wherein the water-insoluble polymer is formed by crosslinking a water-soluble polymer.

Embodiment 16 is the porous article of embodiment 15, wherein the water-soluble polymer comprises poly(lactic-co-glycolic acid), poly(ethyleneimine), or a combination thereof.

Embodiment 17 is a method of forming the article of embodiment 13, the method comprising:
exposing the poly(vinyl alcohol) to a solution comprising a carrier liquid and a second polymer;
removing the carrier liquid, and optionally crosslinking the second polymer.

Embodiment 18 is a method of forming a porous article comprising:
a porous substrate comprising ePTFE; and
a coating disposed on the porous substrate, the coating comprising poly(vinyl alcohol),
the method comprising:
   applying a first coating composition to the porous substrate, the first coating composition comprising an aqueous solution comprising poly(vinyl alcohol);
   removing the aqueous solution and leaving a film of poly(vinyl alcohol) on the substrate; and
   applying a second coating composition to the film of poly(vinyl alcohol), the second coating compositions comprising a solution of poly(lactic-co-glycolic acid) in tetrahydrofuran.

Embodiment 19 is a method of forming a porous article comprising:
a porous substrate comprising ePTFE; and
a coating disposed on the porous substrate, the coating comprising poly(vinyl alcohol),
the method comprising:
   applying a first coating composition to the porous substrate, the first coating composition comprising an aqueous solution comprising poly(vinyl alcohol);
   removing the aqueous solution and leaving a film of poly(vinyl alcohol) on the substrate;
   applying a second coating composition to the film of poly(vinyl alcohol), the second coating compositions comprising poly(ethyleneimine) in methanol with a formaldehyde crosslinking agent; and
   evaporating the methanol at an elevated temperature to effect crosslinking of the poly(ethyleneimine).

Embodiment 20 is a method of forming a porous article comprising:
a porous substrate comprising ePTFE; and
a coating disposed on the porous substrate, the coating comprising poly(vinyl alcohol),
the method comprising:
   applying a first coating composition to the porous substrate, the first coating composition comprising an aqueous solution comprising poly(vinyl alcohol);
   removing the aqueous solution and leaving a film of poly(vinyl alcohol) on the substrate;
   applying a second coating composition to the film of poly(vinyl alcohol), the second coating compositions comprising poly(2-hydroxyethylmethacrylate) in isopropanol; and
   evaporating the isopropanol.

Embodiment 21 is a porous article made by the method any one of embodiments 18 to 20.

Embodiment 22 is a filter comprising a housing with an interior, an inlet, and an outlet, and filter media disposed within the interior of the housing and comprising the porous article of any of the preceding embodiments.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. It should be understood that this disclosure is not intended to be unduly limited by the illustrative embodiments and examples set forth herein and that such examples and embodiments are presented by way of example only with the scope of the disclosure intended to be limited only by the claims set forth here.

What is claimed is:

1. A porous article comprising:
a porous substrate comprising ePTFE; and
a coating disposed on the porous substrate, the coating comprising poly(vinyl alcohol) and a biological molecule covalently attached to the poly(vinyl alcohol), optionally wherein the biological molecule comprises an amino acid, a polypeptide, a saccharide, a polysaccharide, or a combination of two or more thereof.

2. A method of forming the article of claim 1, the method comprising:
covalently coupling the biological molecule to the poly(vinyl alcohol) to form the porous article, optionally wherein the biological molecule and the poly(vinyl alcohol) react in a bioconjugation reaction.

3. A porous article comprising:
a porous substrate comprising ePTFE; and
a coating disposed on the porous substrate, the coating comprising poly(vinyl alcohol) and a second polymer grafted on the poly(vinyl alcohol), optionally wherein the second polymer comprises polyethylene glycol (PEG), linear polyethylene imine (PEI), polyallyl alcohol (PAIA), polyacrylic acid (PAA), polyacrylic acid sodium salt (PAANa), poly(2-hydroxyethyl methacrylate) (PHEMA), or any combination thereof.

4. A method of forming the article of claim 3, the method comprising:
covalently coupling the second polymer to poly(vinyl alcohol) to form the porous article, optionally wherein the covalently coupling the second polymer comprises reacting a coupling agent with the poly(vinyl alcohol) and the second polymer.

5. A porous article comprising:
a porous substrate comprising ePTFE; and
a first coating disposed on the porous substrate, the coating comprising poly(vinyl alcohol); and
a second coating disposed on the first coating, the second coating comprising a water-insoluble polymer.

6. A method of forming the article of claim 5, the method comprising:
exposing the poly(vinyl alcohol) to a solution comprising a carrier liquid and a second polymer;
removing the carrier liquid; and
optionally crosslinking the second polymer.
